(19) United States
(12) Patent Application Publication
(10) Pub. No.: US 2024/0418894 A1
(43) Pub. Date: Dec. 19, 2024

(54) SYSTEMS AND METHODS FOR A WELL INTEGRITY MANAGEMENT TOOL

(71) Applicant: SAUDI ARABIAN OIL COMPANY, Dhahran (SA)

(72) Inventors: Sanjiv KUMAR, Udhailiyah (SA); Ahmed ALQAHTANI, Udhailiyah (SA)

(73) Assignee: SAUDI ARABIAN OIL COMPANY, Dhahran (SA)

(21) Appl. No.: 18/334,923

(22) Filed: Jun. 14, 2023

(51) Int. Cl. G01V 1/50

(52) U.S. Cl. CPC G01V 1/50

(57) ABSTRACT

In some examples, a system can include a well integrity management tool includes an identifier, implemented by at least one processor, configured to identify one or more risks associated with a well based on well integrity data, a risk analyzer, implemented by the at least one processor, configured to determine a classification for the well based on a set of one or more identified risks using a risk model, wherein the risk model associates a category and a weight with each identified risk of the set of one or more identified risks, and a remediator, implemented by the at least one processor, configured to generate a remediation plan based on the classification.

### FIELD OF THE DISCLOSURE

This disclosure relates generally to determining well risks and remediation plans during a well lifecycle.

### BACKGROUND OF THE DISCLOSURE

A well lifecycle includes multiple stages, such as planning, drilling, completion, production, shut in, or other like labels. Regardless of the type of well or the lifecycle stage of the well, maintaining well integrity throughout the life of the well is important to ensuring the health and safety of personnel, assets, and the environment.

Well integrity management becomes important and challenging as the well gets older. During the initial period, wells show minimal problems, but with aging, the assets of the well need periodic maintenance and close monitoring to sustain trouble-free operation and longer life. Conventional well integrity approaches are valid when the wells are new and few. However, as the wells age and the number of wells increases, maintaining the integrity on an individual gets more complicated, leading to increased likelihood of well integrity failure and before discovery of its root causes.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Broadly, in certain aspects, the disclosure herein shifts the paradigm from a conventional reactive approach to a proactive approach where a well risk model provides a methodology to engineers by categorizing a well considering all well integrity related data in combination (and not in isolation as done conventionally) and classifying the well according to associated risk leading to a proactive remediation actions plan which is generated to restore the integrity of the well accordingly. The proposed risk ranking model categorizes wells as very high risk (>=100), high risk (between 100 and 64), medium risk (between 64 to 16) and low risk (lower than 16). All of the risks are based on three categories viz. Manageability, well problems and impact.

Manageability: under this category are risks associated with well completion and accessibility to the reservoir.

Well Problem: under this category are risks associated with operations.

Impact: under this category are risks associated with location or environmental concerns.

According to an embodiment consistent with the present disclosure, a well integrity management tool includes an identifier, implemented by at least one processor, configured to identify one or more risks associated with a well based on well integrity data, a risk analyzer, implemented by the at least one processor, configured to determine a classification for the well based on a set of one or more identified risks using a risk model, wherein the risk model associates a category and a weight with each identified risk of the set of one or more identified risks, and a remediator, implemented by the at least one processor, configured to generate a remediation plan based on the classification.

In another embodiment consistent with the present disclosure, a method for managing well integrity includes identifying one or more risks associated with a well based on well integrity data, determining a cumulative risk weight for the well based on one or more identified risks using a risk model, wherein the risk model associates a risk rating and a weight with each identified risk of the one or more identified risks, and generating a remediation plan based on a cumulative risk weight.

According to another embodiment consistent with the present disclosure, a non-transitory computer-readable medium is configured to store computer-executable instructions, which, when executed by a processor, cause the processor to identify one or more risks associated with a well based on well integrity data, determine a classification for the well based on one or more identified risks using a risk model, wherein the risk model associates a category and a weight with each identified risk of the one or more identified risks, and generate a remediation plan based on the classification.

Any combinations of the various embodiments and implementations disclosed herein can be used in a further embodiment, consistent with the disclosure. These and other aspects and features are better appreciated according to the following description of certain embodiments presented herein in accordance with the disclosure and the accompanying drawings and claims.

### BRIEF DESCRIPTION OF THE DRAWINGS

FIG. 1 is a block diagram of a system for a well integrity management (WIM) tool in accordance with certain embodiments.

FIG. 2 is a flow diagram of a method for a well integrity management tool, in accordance with certain embodiments.

FIG. 3 is a block diagram of a computer system that can be employed to implement a well integrity management tool, in accordance with certain embodiments.

### DETAILED DESCRIPTION

Embodiments of the present disclosure will now be described in detail with reference to the accompanying Figures. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to determining well risks and remediation plans during a well lifecycle, and more particularly, to systems and methods for a well integrity management tool. As described above, maintaining well integrity is important to ensuring the health and safety of personnel, assets, and the environment. Maintaining well integrity includes

As a well ages, the number of tasks associated with maintaining well integrity increases. For example, asset aging may increase an amount of monitoring, maintenance, or a combination thereof, needed to prevent interruption of operations.

Additionally, the well integrity management tool can be used in other industries outside of oil and gas, for example, in the mining industry, the quarry industry, the hydrological industry, the liquid waste disposal industry, the geothermal energy industry, the geologic greenhouse gas storage industry, or like industries in which drilling of subterranean formations can be performed. Thus, the well integrity management tool as described herein can be used in any environment or industry to remediate risky conditions of wells.

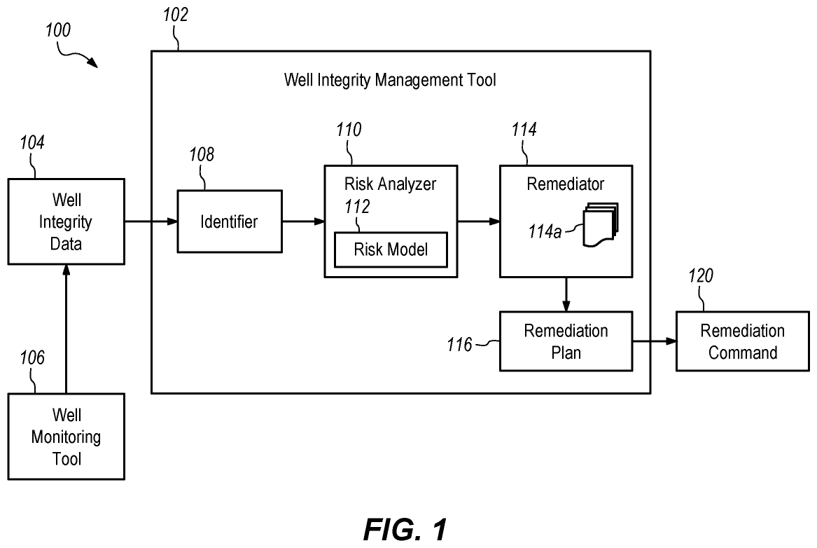

FIG. 1 is an example of a system 100 for a well integrity management (WIM) tool 102 that is configured to receive well integrity data 104, for example from a well monitoring tool 106 and/or other sources (not shown), in accordance with certain embodiments. The well monitoring tool 106 may be downhole and surface pressure sensors, downhole and surface temperature sensors, flowmeters, annuli pressure recorders, and so on. The other sources may be manually recorded surveys like corrosion logs, landing base inspection results, well head integrity test, and so on.

The well integrity data 104 is received by an identifier module 108 of the WIM tool 102, which is configured to identify a set of one or more risks associated with a well based on the well integrity data 104. Table 1 lists some risk types in the first column as well as an associated weight assignment in the second column, as may be identified by identifier module 108. The weight assignments may be a first weight (e.g. 4) low risk, and the subsequent assignments may be a multiplier (4) of the low risk (4×4=16) for the medium risk; and the subsequent assignment may be a multiplier (3) of the medium risk (3×16=64), and so on.

TABLE 1

| RISK TYPE DESCRIPTION | WEIGHT |
|---|---|
| RESERVOIR ISOLATION NOT POSSIBLE | 64 |
| SURFACE INACCESSIBILITY | 16 |
| CASING LEAK-FRESH WATER/AQUIFER | 100 |
| CONTAMINATION | |
| WELL NOT ABANDONED AS REQUIRED | 64 |
| BEHIND PIPE FLOW | 4 |
| GREATER THAN 75% OF MAX PRODUCTION | 64 |
| TREE PRESSURE TEST | |
| ANNULI PROBLEM-PACKER LEAK | 64 |
| ANNULI PROBLEM-TUBING LEAK | 64 |
| DOWNHOLE CASING LEAK | 64 |
| SURFACE CASING CORRODED-MINOR | 4 |
| TCA > PRESSURE LIMIT | 64 |
| CCA > PRESSURE LIMIT | 64 |
| SURFACE CASING CORRODED-MODERATE | 16 |
| SURFACE CASING CORRODED-SEVERE | 64 |
| ZERO TCA | 16 |
| TUBING OBSTRUCTION | 16 |
| STUCK CLOSED VALVES/WELL HEAD | 64 |
| OBSTRUCTION | |
| LEAKING AT OR BELOW MV | 100 |
| RADIACTIVE SOURCE IN THE WELLBORE | 4 |
| TUBING METAL LOSS Severe | 64 |
| WORKOVER AGE >15 | 16 |
| TUBING METAL LOSS Moderate | 16 |
| TUBING WALL LOSS >50% | 16 |
| LOSS CIRCULATION/POOR CEMENT BOND | 4 |
| HYDROCARBON LEAK (SURFACE LEAK | 100 |
| AROUND WH/PAD) | |
| WELL IN POPULATED AREA | 16 |

WIM tool 102 also includes a risk analyzer 110 that receives the output of identifier 108 and uses a risk model 112 to determine an overall risk that considers all the associated risks and weightages for the well based on the received set of one or more risks. All individual risk weightages are added to arrive at the cumulative risk number which is the basis for assigning overall risk for that particular well. For example, if the risks add up to 108 (60+16+16+16), then the well is flagged as ‘Very high risk’ well. The risk factors, for ease of understanding, can be classified into three categories:
Manageability: Risks associated with well completion and accessibility to the reservoir.
Well Problem: Risks associated with operations.
Impact: Risks associated with location or environmental concerns.

A remediator module 114 is operable to issue a remediation plan 116 for the well based on the classification output of the risk analyzer 110. In certain embodiments, one or more remediation commands 120 to implement a remediation may also be issued for delivery and potential execution. In certain embodiments, the remediator module 114 has many inbuild remediation decision trees 114a, leading to problem remediation and ultimately reducing the risk. For example, if the well is associated with annuli problem with surface communication issue then a repacking job is suggested. Similarly, if the well has severe corrosion leading to high risk then a workover is suggested, and so on. Remediation commands 120 may be issued for each such job(s). If the well is determined to have more than one associated risk by risk analyzer 110, then remediator 114 may be executed for each of the multiple risks, and remediation commands 120 for each of the risk are issued. In certain embodiments, an exception may be implemented in the field by the well services.

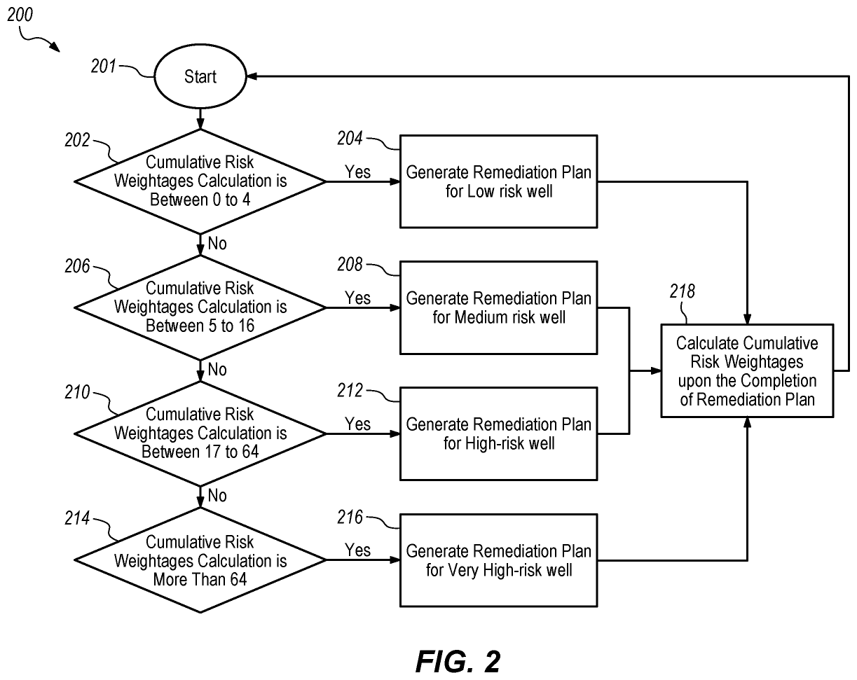

In certain embodiments, WIM 102 operates in accordance with the workflow 200 shown in FIG. 2, beginning at 201. At 202, a determination is made by risk analyzer 110 of whether the cumulative risk weightages are for example in the range of 0 to 4, and a low risk well remediation plan is generated by remediator 114 at 204. At 206, a determination is made by risk analyzer 110 of whether the cumulative risk weightages are for example in the range of 5 to 16, and a medium risk well remediation plan is generated by remediator 114 at 208. At 210, a determination is made by risk analyzer 110 of whether the cumulative risk weightages are for example in the range of 17 to 64, and a high risk well remediation plan is generated by remediator 114 at 212. At 214, a determination is made by risk analyzer 110 of whether the cumulative risk weightages are for example greater than 64, and a very-high risk well remediation plan is generated by remediator 114 at 216.

As seen in workflow 200, WIM 102 is further operable to calculate cumulative risk weightages upon completion of the remediation plans, at 218, and to loop back to the beginning at 201 to thereby assess the effectiveness of the mitigations. The process can be repeated indefinitely to identify additional risks from newly-acquired well integrity data 104. Workflow 200 calculates cumulative risk and based on overall risk value, classifies the well into one of four categories; low risk, medium risk, high risk and very high-risk wells. Then the remediator 114 issues one or more remediation plans 116 based on associated risk and issues a remediation command 120 based on the remediation plan. Once the remediation command 120 is executed, the well is subjected to re-capturing of well integrity data 104 and the identifier 108 identifies lower risk followed by risk analyzer to calculate the overall risk and reclassifies the well to lower risk and the cycle repeats.

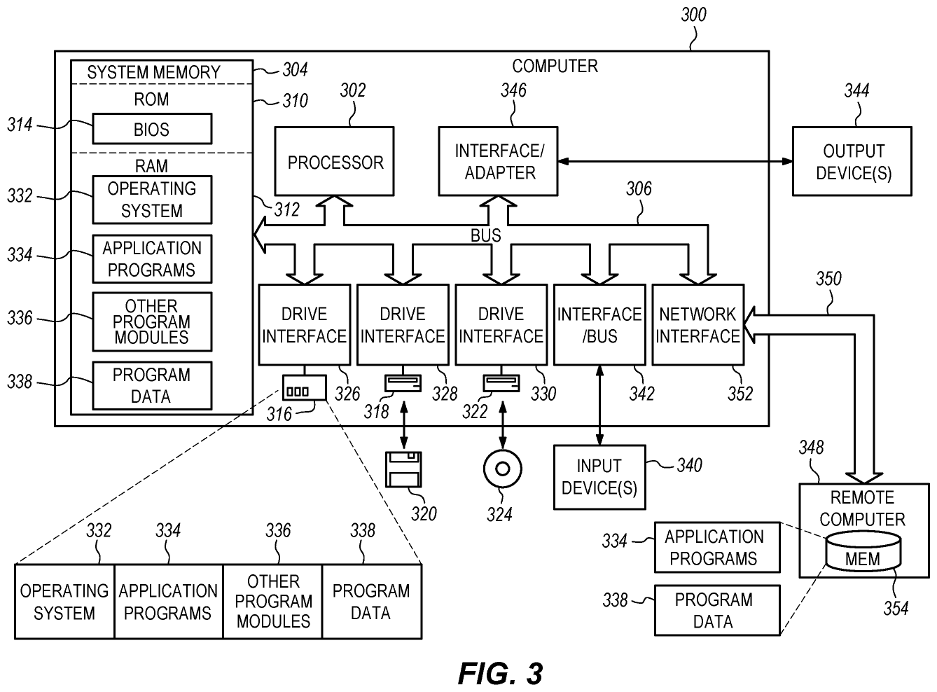

In view of the foregoing structural and functional description, those skilled in the art will appreciate that portions of the embodiments described herein may be implemented as a method, data processing system, or computer program product (e.g., computer application). Accordingly, these portions of the present disclosure may take the form of an entirely hardware embodiment, an entirely software embodiment, or an embodiment combining software and hardware, such as shown and described with respect to the computer system of FIG. 3. Furthermore, portions of the embodiments herein may be a computer program product on a computer-readable medium having computer-readable program code on the medium. Any suitable non-transitory computer-readable medium may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other integrated circuit (IC) (such, as for example, a field-programmable gate array (FPGA) or an application-specific integrated circuit (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), a magnetic tape, a holographic storage medium, a solid-state drive (SSD), a RAM drive, a SECURE DIGITAL card, a SECURE DIGITAL drive, or another suitable computer-readable medium or a combination of two or more of these, where appropriate. A non-transitory computer-readable medium may be volatile, nonvolatile, or a combination of volatile and non-volatile, as appropriate.

Certain embodiments described herein have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks. These computer-executable instructions may also be stored in a computer-readable medium that can direct a computer or other programmable data processing apparatus to function in a particular manner, such that the instructions stored in the computer-readable medium result in an article of manufacture including instructions which implement the function specified in the flowchart block or blocks. The computer-executable instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

FIG. 3 is a block diagram of a computer system 300 that can be employed to execute a system including a well integrity management tool, in accordance with certain embodiments described. The computer system 300 may be the system 100 of FIG. 1, for example. Computer system 300 can be implemented on one or more general purpose networked computer systems, embedded computer systems, routers, switches, server devices, client devices, various intermediate devices/nodes or standalone computer systems. Additionally, computer system 300 can be implemented on various mobile clients such as, for example, a personal digital assistant (PDA), a smartphone, a laptop computer, a pager, and the like, provided it includes sufficient processing capabilities.

Computer system 300 includes processing unit 302, system memory 304, and system bus 306 that couples various system components, including the system memory 304, to processing unit 302. Dual microprocessors and other multi-processor architectures also can be used as processing unit 302. System bus 306 may be any of several types of bus structure including a memory bus or memory controller, a peripheral bus, and a local bus using any of a variety of bus architectures. System memory 304 includes read only memory (ROM) 310 and random access memory (RAM) 312. A basic input/output system (BIOS) 314 can reside in ROM 310 containing the basic routines that help to transfer information among elements within computer system 300. In other examples, a Unified Extensible Firmware Interface (UEFI) or other set of specification defining platform architecture and firmware includes the basic routines that help to transfer information among elements within computer system 300.

Computer system 300 can include a hard disk drive 316, magnetic disk drive 318, e.g., to read from or write to removable disk 320, and an optical disk drive 322, e.g., for reading CD-ROM disk 324 or to read from or write to other optical media. Hard disk drive 316, magnetic disk drive 318, and optical disk drive 322 are connected to system bus 306 by a hard disk drive interface 326, a magnetic disk drive interface 328, and an optical drive interface 330, respectively. The drives and associated computer-readable media provide nonvolatile storage of data, data structures, and computer-executable instructions for computer system 300. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more components of embodiments shown and described herein.

A number of program modules may be stored in drives and RAM 312, including operating system 332, one or more computer application programs 334, other program modules 336, and program data 338. In some examples, the computer application programs 334 can include one or more of WIM tool 102, identifier 108, risk analyzer 110 and remediator 114 for instance, and the program data 338 can include one or more of the remediation plan 116 and remediation command 120 for instance. The application programs 334 and program data 338 can include functions and methods programmed to manage well integrity, such as shown and described herein.

A user may enter commands and information into computer system 300 through one or more input devices 340, such as a pointing device (e.g., a mouse, touch screen), keyboard, microphone, joystick, game pad, scanner, and the like. These and other input devices 340 are often connected to processing unit 302 through a corresponding port interface 342 that is coupled to the system bus, but may be connected by other interfaces, such as a parallel port, serial port, or universal serial bus (USB). One or more output devices 344 (e.g., display, a monitor, printer, projector, or other type of displaying device) is also connected to system bus 306 via interface 346, such as a video adapter.

Computer system 300 may operate in a networked environment using logical connections to one or more remote computers, such as remote computer 348. Remote computer 348 may be a workstation, computer system, router, peer device, or other common network node, and typically includes many or all the elements described relative to computer system 300. The logical connections, schematically indicated at 350, can include a local area network (LAN) and a wide area network (WAN). When used in a LAN networking environment, computer system 300 can be connected to the local network through a network interface or adapter 352. When used in a WAN networking environment, computer system 300 can include a modem, or can be connected to a communications server on the LAN. The modem, which may be internal or external, can be connected to system bus 306 via an appropriate port interface. In a networked environment, computer application programs 334 or program data 338 depicted relative to computer system 300, or portions thereof, may be stored in a remote memory storage device 354.

### Additional Embodiments

Embodiments disclosed herein include:

A. A well integrity management tool comprising:
an identifier, implemented by at least one processor, configured to identify one or more risks associated with a well based on well integrity data;
a risk analyzer, implemented by the at least one processor, configured to determine a classification for the well based on a set of one or more identified risks using a risk model, wherein the risk model associates a category and a weight with each identified risk of the set of one or more identified risks; and
a remediator, implemented by the at least one processor, configured to generate a remediation plan based on the classification.
   B. A method for managing well integrity, comprising:
identifying one or more risks associated with a well based on well integrity data;
determining a cumulative risk weight for the well based on one or more identified risks using a risk model, wherein the risk model associates a risk rating and a weight with each identified risk of the one or more identified risks; and
generating a remediation plan based on a cumulative risk weight.
   C. A non-transitory computer-readable medium storing computer-executable instructions, which, when executed by a processor, cause the processor to:
identify one or more risks associated with a well based on well integrity data;
determine a classification for the well based on one or more identified risks using a risk model, wherein the risk model associates a category and a weight with each identified risk of the one or more identified risks; and
generate a remediation plan based on the classification.

Each of embodiments A through C may have one or more of the following additional elements in any combination: Element 1: wherein the identifier is further configured to identify a second set of one or more risks associated with the well based on a second set of well integrity data, wherein the risk analyzer is further configured to determine a second classification for the well based on the second set of one or more identified risks using the risk model, and wherein the remediator is configured to generate a second remediation plan based on the second classification. Element 2: wherein remediator is configured to issue a remediation command based on the remediation plan. Element 3: wherein the well integrity management tool is operable to re-capture well integrity data following execution of the remediation command issued by the remediator. Element 4: wherein the identifier is operable to identify risk from re-captured well integrity data. Element 5: wherein the risk analyzer is operable to calculate overall risk and reclassify the well based on identification by the. Element 6: wherein the risk model includes at least four risk ratings, wherein a first risk rating of the at least four risk ratings is associated with a first weight, wherein each risk rating subsequent to the first risk rating is associated with different subsequent weight, and wherein each subsequent weight of the different subsequent weights is a multiplier of the first weight. Element 7: wherein the classification is based on a cumulative risk rating for the well, and wherein the cumulative risk rating is determined by summing the weights of the one or more identified risks.

By way of non-limiting example, exemplary combinations applicable to A through C include: Element 1 with Element 2; Element 1 with Element 3; Element 1 with Element 4; Element 1 with Element 5; Element 1 with Element 6; Element 1 with Element 7; Element 2 with Element 6; and Element 2 with Element 7.

The terminology used herein is for the purpose of describing particular embodiments only and is not intended to limit this disclosure. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. Also, the phraseology and terminology used herein is for the purpose of description and should not be regarded as limiting. The use of “including,” “comprising,” “having,” “containing,” “involving,” and variations thereof herein, is meant to encompass items listed thereafter and equivalents thereof as well as additional items. While the disclosure has described several exemplary embodiments, it will be understood by those skilled in the art that various changes can be made, and equivalents can be substituted for elements thereof, without departing from the spirit and scope of the invention.

In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

The invention claimed is:

1. A well integrity management tool comprising:
an identifier, implemented by at least one processor, configured to identify one or more risks associated with a well based on well integrity data;
a risk analyzer, implemented by the at least one processor, configured to determine a classification for the well based on a set of one or more identified risks using a risk model, wherein the risk model associates a category and a weight with each identified risk of the set of one or more identified risks; and
a remediator, implemented by the at least one processor, configured to generate a remediation plan based on the classification.

2. The well integrity management tool of claim 1, wherein the identifier is further configured to identify a second set of one or more risks associated with the well based on a second set of well integrity data, wherein the risk analyzer is further configured to determine a second classification for the well based on the second set of one or more identified risks using the risk model, and wherein the remediator is configured to generate a second remediation plan based on the second classification.

3. The well integrity management tool of claim 1, wherein the remediator is configured to issue a remediation command based on the remediation plan.

4. The well integrity management tool of claim 3, wherein the well integrity management tool is operable to re-capture well integrity data following execution of the remediation command issued by the remediator.

5. The well integrity management tool of claim 4, wherein the identifier is operable to identify risk from re-captured well integrity data.

6. The well integrity management tool of claim 5, wherein the risk analyzer is operable to calculate overall risk and reclassify the well based on identification by the.

7. The well integrity management tool of claim 1, wherein the risk model includes at least four risk ratings, wherein a first risk rating of the at least four risk ratings is associated with a first weight, wherein each risk rating subsequent to the first risk rating is associated with different subsequent weight, and wherein each subsequent weight of the different subsequent weights is a multiplier of the first weight.

8. The well integrity management tool of claim 7, wherein the classification is based on a cumulative risk rating for the well, and wherein the cumulative risk rating is determined by summing the weights of the one or more identified risks.

9. A method for managing well integrity, comprising:
identifying one or more risks associated with a well based on well integrity data;
determining a cumulative risk weight for the well based on one or more identified risks using a risk model, wherein the risk model associates a risk rating and a weight with each identified risk of the one or more identified risks; and
generating a remediation plan based on a cumulative risk weight.

10. The method for managing well integrity of claim 9, further comprising:
performing one or more steps of the remediation plan;
identifying a second set of one or more risks associated with a well based on a second set of well integrity data;
determining a second cumulative risk weight for the well based on the second set of one or more identified risks using the risk model; and
generating a second remediation plan based on the second cumulative risk weight.

11. The method of claim 9, wherein the risk model includes at least four risk ratings, and wherein each risk rating of the at least four risk ratings is associated with a different weight.

12. The method for managing well integrity of claim 11, further comprising aggregating each identified risk of the one or more identified risks into risk groups based on risk ratings, wherein a risk group includes a subset of the one or more identified risks having an equivalent weight.

13. The method for managing well integrity of claim 12, further comprising determining a cumulative weight for each risk group of the risk groups by multiplying the equivalent weight by a total number of the subset of the one or more identified risks having the equivalent weight.

14. The method for managing well integrity of claim 13, further comprising determining a cumulative risk weight for the well by summing the cumulative weights for each risk group.

15. The method for managing well integrity of claim 14, further comprising:
determining a range of multiple, non-overlapping ranges including the cumulative risk weight; and
generating the remediation plan based on the range.

16. The method for managing well integrity of claim 15, wherein the weight associated with each identified risk of the one or more identified risks is one of at least four different weights, wherein the multiple non-overlapping ranges includes at least four ranges, and wherein an upper limit of each range of the at least four ranges is equivalent to one of the at least four different weights.

17. A non-transitory computer-readable medium storing computer-executable instructions, which, when executed by a processor, cause the processor to:
identify one or more risks associated with a well based on well integrity data;
determine a classification for the well based on one or more identified risks using a risk model, wherein the risk model associates a category and a weight with each identified risk of the one or more identified risks; and
generate a remediation plan based on the classification.

18. The non-transitory computer-readable medium of claim 15, wherein the processor is further operable to:
transmit a remediation command to a well monitoring tool;
identify a second set of one or more risks associated with the well based on a second set of well integrity data;
determine a second classification for the well based on the second set of one or more identified risks using the risk model; and
generate a second remediation plan based on the second classification.

19. The non-transitory computer-readable medium of claim 18, wherein the processor is further operable to:
determine a cumulative risk weight for the well by summing the weights associated with the one or more identified risks; and
determine a range of multiple, non-overlapping ranges including the cumulative risk weight.

20. The non-transitory computer-readable medium of claim 19, wherein the processor is further operable to:
determine the classification for the well based on the range.
